(19) United States
(12) Patent Application Publication
(10) Pub. No.: US 2021/0283726 A1
(43) Pub. Date: Sep. 16, 2021

(54) SOLDER MATERIAL

(71) Applicant: KEIHIN CORPORATION, Tokyo (JP)

(72) Inventors: Yukihiko Hirai, Utsunomiya-shi, Tochigi-ken (JP); Kouki Oomori, Utsunomiya-shi, Tochigi-ken (JP); Hayato Morofushi, Shioya-gun, Tochigi-ken (JP)

(21) Appl. No.: 17/255,684

(22) PCT Filed: Jun. 20, 2019
(86) PCT No.: PCT/JP2019/024411

§ 371 Date: Dec. 23, 2020

(30) Foreign Application Priority Data
Sep. 28, 2018 (JP) 2018-184789

(51) Int. Cl. B23K 35/26

(52) U.S. Cl. CPC B23K 35/262; B23K 2103/08

(57) ABSTRACT

A solder material comprises 0.5% (% by weight, same as below) or more and less than 2.5% of Ag, 0.3 to 0.5% Cu, 5.5 to of 6.4% of In and 0.5 to 1.4% of Sb, with the remainder made up by unavoidable impurities and Sn. Alternatively, the solder material comprises 2.5 to 3.3% of Ag, 0.3 to 0.5% of Cu, 2.5% or more and less than 5.5% of In and 0.5 to 1.4% of Sb, with the remainder made up by unavoidable impurities and Sn. The solder material may comprise 2.5 to 3.3% of Ag, 0.3 to 0.5% of Cu, 5.5 to 6.4% of In, and more than 1.4% and 3.4% or less of Sb, with the remainder made up by unavoidable impurities and Sn. In each of the solder material, Bi is not substantially contained.

### TECHNICAL FIELD

The present invention relates to a solder material which is used as a joining material when joining objects together.

### BACKGROUND ART

Electronic components such as transistors, diodes, and thyristors are joined to a substrate through a solder material. Conventionally, as such a solder material, a material containing lead (Pb) as a principal component thereof has been used. However, in recent years, due to an increasing awareness in protecting the environment, such a solder material is in the process of being replaced by a so-called Pb-free solder material that does not contain Pb.

A Pb-free solder material contains tin (Sn) as a principal component thereof, together with silver (Ag) and copper (Cu) as secondary components for promoting precipitation strengthening. Furthermore, it is known that solid-solution strengthening can be accomplished by adding indium (In) and antimony (Sb). For example, in Japanese Laid-Open Patent Publication No. 2002-120085, a solder material is disclosed containing 2.5 to 4.5% by weight of Ag, 0.2 to 2.5% by weight of Cu, less than or equal to 12% by weight of In, and less than or equal to 2% by weight of Sb, with the remainder being Sn. Furthermore, in International Publication No. WO 1997/009455, a solder material is disclosed containing 1.4 to 7.1% by weight of Ag, 0.5 to 1.3% by weight of Cu, 0.2 to 9.0% by weight of In, and 0.4 to 2.7% by weight of Sb, with the remainder being Sn. In some cases, bismuth (Bi) may also be added.

### SUMMARY OF INVENTION

A substrate to which the above-described electronic components have been joined constitutes, for example, a vehicle-mounted engine control unit that is installed in an automobile and serves to control the engine. In such a case, situations may occur in which the automobile is used under an extremely cold environment or under an extremely hot environment. For this reason, it is necessary to ensure operations within a wide temperature range.

However, it is recognized that such well-known Pb-free solder materials tend to vary in the mechanical properties thereof, particularly under an extremely low temperature environment. Accordingly, in the case that the automobile is used under an extremely cold environment, a concern arises in that variations may occur in the product lifespan of the vehicle-mounted engine control unit. In the foregoing manner, the solder material according to the conventional technique has a disadvantage in that the reliability thereof is insufficient when put to use under an extremely low temperature environment.

A principal object of the present invention is to provide a solder material that exhibits stable mechanical properties even at extremely low temperatures.

Another object of the present invention is to provide a solder material which enables obtaining sufficient reliability even when put to use under an extremely low temperature environment.

In order to achieve the aforementioned objects, according to one embodiment of the present invention, there is provided a solder material containing 0.5 to less than 2.5% by weight of Ag, 0.3 to 0.5% by weight of Cu, 5.5 to 6.4% by weight of In, and 0.5 to 1.4% by weight of Sb, with a remainder being unavoidable impurities and Sn, and containing substantially no Bi. It should be noted that, for example, the phrase “0.3 to 0.5% by weight” implies “a range of greater than or equal to 0.3% by weight and less than or equal to 0.5% by weight”, and the phrase “0.5 to less than 2.5% by weight” implies “a range of greater than or equal to 0.5% by weight and less than 2.5% by weight”. The same definitions apply to the other numerical ranges.

According to another embodiment of the present invention, there is provided a solder material containing 2.5 to 3.3% by weight of Ag, 0.3 to 0.5% by weight of Cu, 2.5 to less than 5.5% by weight of In, and 0.5 to 1.4% by weight of Sb, with a remainder being unavoidable impurities and Sn, and containing substantially no Bi.

According to still another embodiment of the present invention, there is provided a solder material containing 2.5 to 3.3% by weight of Ag, 0.3 to 0.5% by weight of Cu, 5.5 to 6.4% by weight of In, and more than 1.4 to 3.4% by weight of Sb, with a remainder being unavoidable impurities and Sn, and containing substantially no Bi. In this instance, the phrase “more than 1.4 to 3.4% by weight” implies “greater than 1.4% by weight and less than or equal to 3.4% by weight”.

By using any of the three compositions listed above, a solder material having a lower melting point can be obtained. Due to having such a low melting point, it is possible to lower the temperature applied to the solder material at the time of joining. Accordingly, it is possible to reduce thermal damage applied to the objects to be joined, for example, electronic components.

In addition, from the fact that the addition of solid solution elements is of a small amount, the occurrence of twinning deformation is unlikely, and the formation of hypereutectic products is suppressed, and therefore, variation in the mechanical properties is reduced. Further, variation in the useful lifetime of the joint is reduced, and as a result, the product lifespan of the joined products is stabilized. Therefore, reliability is improved. The features mentioned above will be described in detail later.

As has been described above, the solder material according to the present invention substantially does not contain any Bi therein. In accordance with this feature, the solder material exhibits stable mechanical properties. The term “substantially does not contain” as used herein implies an amount that is inevitably mixed therein, and does not include an amount in excess of such an amount.

According to the present invention, the solder material is made up of a composition, which contains predetermined amounts of Ag, Cu, In, Sb, and Sn, and which substantially does not contain any Bi therein. Therefore, it is possible to obtain a solder material which has a low melting point and in which the variation in the mechanical properties is small. Accordingly, it is possible to reduce thermal damage applied to the joined products, suppress variation in the product lifespan, and improve reliability.

### BRIEF DESCRIPTION OF DRAWINGS

FIG. 1 is a diagram in which there are shown components, and composition ratios and physical properties thereof of No. 1 to No. 14 solder materials (test pieces);

FIGS. 2A, 2B, and 2C show, respectively, stress-strain curves of No. 7, No. 3, and No. 10 solder materials;

FIGS. 3A, 3B, and 3C show, respectively, stress-strain curves of No. 11, No. 12, and No. 14 solder materials; and

FIG. 4 is a graph showing the tensile strength, and variations thereof of No. 1 to No. 14 solder materials.

### DESCRIPTION OF EMBODIMENTS

Preferred embodiments of solder materials according to the present invention will be presented and described in detailed below with reference to the accompanying drawings. Hereinafter, the term % by weight may also be referred to simply by “%”.

Any of the solder materials according to the first to third embodiments are so-called Pb-free solder materials, which contain Sn as a principal component, and Ag and Cu as components that promote precipitation strengthening, with In and Sb being further added thereto.

The solder material according to the first embodiment is made of an alloy containing 0.5 to less than 2.5% of Ag, 0.3 to 0.5% of Cu, 5.5 to 6.4% of In, and 0.5 to 1.4 % of Sb, with the remainder being unavoidable impurities and Sn.

Further, the solder material according to the second embodiment is made of an alloy containing 2.5 to 3.3% of Ag, 0.3 to 0.5% of Cu, 2.5 to less than 5.5% of In, and 0.5 to 1.4% of Sb, with the remainder being unavoidable impurities and Sn.

Furthermore, the solder material according to the third embodiment is made of an alloy containing 2.5 to 3.3% of Ag, 0.3 to 0.5% of Cu, 5.5 to 6.4% of In, and more than 1.4 to 3.4% of Sb, with the remainder being unavoidable impurities and Sn.

Precipitation strengthening is promoted by having the composition contain Ag therein. In this instance, when the tensile strength, which is obtained by carrying out a tensile test a plurality of times under an environment of −40°C. on test pieces of Sn—Ag—Cu—In—Sb alloys in which the amount of Ag Is 3.0% and 3.5%, is plotted, it can be seen that when the amount of Ag is 3.5%, the variation in the tensile strength is greater than when the amount of Ag is 3.0%.

As the reason therefor, it may be surmised that when the amount of Ag is 3.5% due to the fact that an Sn—Ag eutectic composition is obtained, a structure is obtained which is a mixture of hypoeutectic, eutectic, and hypereutectic compositions. Therefore, Ag is set to less than or equal to 3.3%, so as not to obtain a eutectic composition. This is because hypoeutectic, eutectic, and hypereutectic compositions are prevented from being mixed in the structure, and a variation in the tensile strength can be suppressed. For this reason, Ag is set to within a range of 0.5 to less than 2.5% in the first embodiment, and within a range of 2.5 to 3.3% in the second and third embodiments.

Precipitation strengthening is promoted in a similar manner by also having the amount of Cu be greater than or equal to 0.3%. On the other hand, in the case of a eutectic composition of Sn—Cu, and more specifically, in the case that the amount of Cu is approximately 0.7%, a structure is obtained which is a mixture of hypoeutectic, eutectic, and hypereutectic compositions, and a variation in the tensile strength occurs. In order to avoid such a situation, the amount of Cu is set to less than or equal to 0.5%.

Further, by adding In, solid-solution strengthening is promoted, and the melting point of the solder material is lowered. More specifically, such a solder material has a lower melting point in comparison with a Pb-free solder material containing only Sn, Ag, and Cu. Therefore, the solder material melts at a low temperature when the electronic components are joined to the substrate.

Meanwhile, when an excessive amount of In is added to Sn, the transformation point of Sn is lowered. For example, at a temperature of greater than or equal to 125° C., the solder material transforms into a γ-phase (InSn₄). Such a secondary phase becomes a cause of variation in the mechanical properties of the solder material. Thus, in order to avoid such a situation, the amount of In is set to 6.4% at a maximum. This is because, in this case, twinning deformation does not occur in the solder material. More specifically, the amount of In is set within a range of 5.5 to 6.4% in the first embodiment and the third embodiment, and is set within a range of 2.5 to less than 5.5% in the second embodiment.

Furthermore, by adding less than or equal to 0.5% of Sb, solid-solution strengthening is promoted. Further, InSn₄ and β-Sn are generated in the liquid phase together with In, and in accordance therewith, the crystal grains are made finer and therefore multi-directional. More specifically, the solder material exhibits almost no anisotropy. In other words, the solder material can be approximated as being isotropic.

Upon determining the stress-strain curves when a tensile test is performed under an environment of −40° C. using a test piece made of an alloy in which the ratio of Sb to Sn was within a range of 1.0% to 3.0%, a result is obtained in which, in spite of the fact that the tensile strength becomes greater as the percentage of Sb increases, the variation in the tensile strength is large.

Furthermore, when the percentage of Sb is set in excess of 3.4%, it can be recognized that, a location in which the stress suddenly decreases or increases, in other words, a disturbance appears in the stress-strain curve. It is presumed that the reason for such a situation is that a slip deformation is not possible owing to the large amount of solid solution elements, and as a result, twinning deformation is more likely to have occurred. In order to avoid such a situation, the amount of Sb is set to less than or equal to 3.4%, which is unlikely to cause twinning deformation. More specifically, the amount of Sb is set within a range of 0.5 to 1.4% in the first embodiment and the second embodiment, and is set within a range of more than 1.4 to 3.4% in the third embodiment.

Upon determining the stress-strain curves when a tensile test is performed under an environment of −40° C. using test pieces made of alloys in which the ratio of Bi to Sn was set to 1.0%, 2.0%, and 3.0%, it can be recognized that the variation becomes large even if the percentage is set to 1.0%, and a disturbance appears in the stress-strain curve even if the percentage is set to 2.0%. The reason for such a situation is considered to be that, in the case that Bi is added, twinning deformation is more likely to occur in comparison with Sn. Therefore, in any of the first to third embodiments, the added amount of Bi is set substantially to zero.

By making use of the compositions as in the first to third embodiments, a solder material which has a low melting point, and in which the variation in the tensile strength is suppressed can be obtained. Therefore, first of all, melting at a low temperature and joining during reflow are made possible, whereby, for example, when the electronic components are joined to the substrate, thermal damage to the electronic components can be reduced.

Further, since the variation in the tensile strength is small, the useful lifetime of the joint at which joined articles are joined using the solder material becomes stable with little variation. Accordingly, reliability is improved. In addition, since a variation in the product lifespan of the joined products (for example, vehicle-mounted engine control units or the like) is suppressed, the degree of freedom in designing such joined products can be enhanced, and high certification and a reduction in size can be achieved.

### Exemplary Embodiments

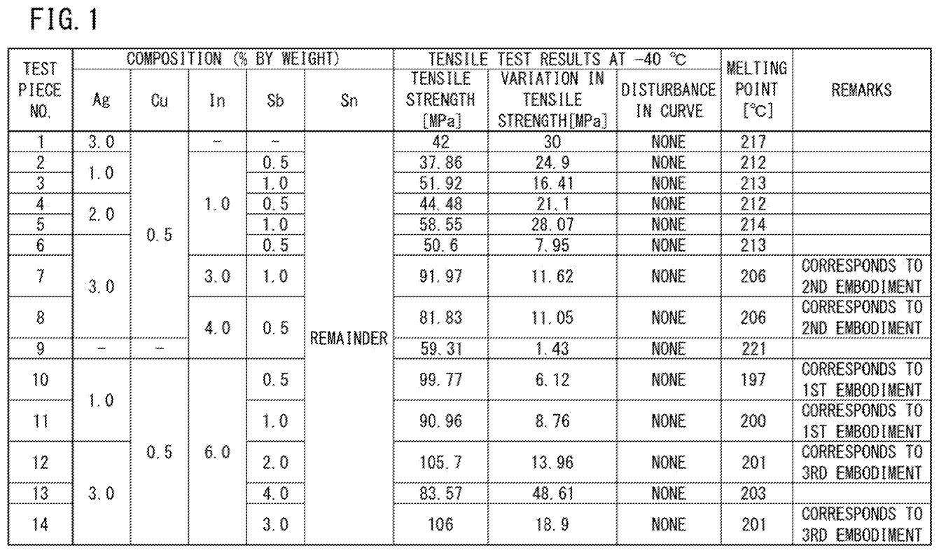

As shown by No. 1 to No. 14 in FIG. 1, a plurality of fourteen types of test pieces made up from solder materials (alloys) were prepared by changing in various ways the composition ratios, and more specifically, the weight percentages of Sn, Ag, Cu, In, and Sb. The No. 10 and the No. 11 test pieces correspond to the first embodiment, the No. 7 and the No. 8 test pieces correspond to the second embodiment, and the No. 12 and the No. 14 test pieces correspond to the third embodiment. The other test pieces are comparative examples in which the composition ratios of any of Ag, Cu, In, and Sb differ from those of the solder materials according to the first to third embodiments.

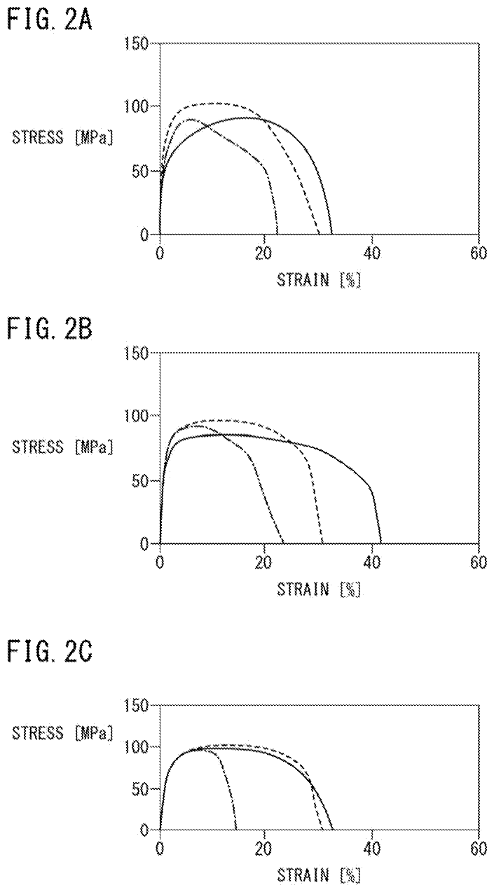

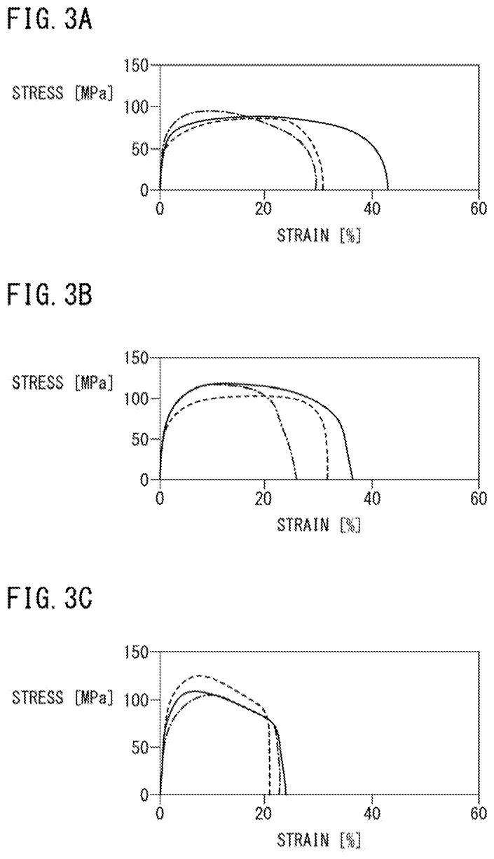

The respective test pieces No. 1 to No. 14 were subjected to a plurality of tensile tests under an environment of −40° C. Stress-strain curves for the No. 7, the No. 8, the No. 10, the No. 11, the No. 12, and the No. 14 test pieces are shown in FIGS. 2A to 3C, with different types of curves in each instance. From FIGS. 2A to 3C, it can be understood that no disturbances exist in the stress-strain curves for the test pieces according to the exemplary embodiments.

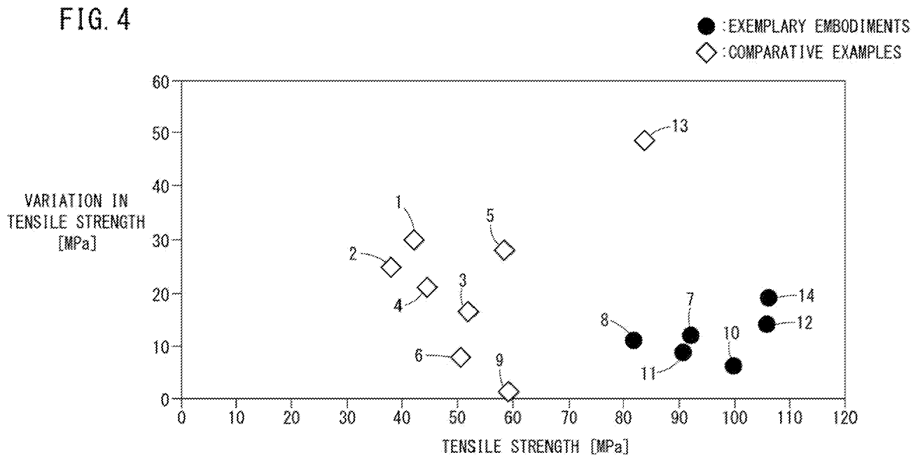

Further, from the results of the tensile tests, the tensile strength and an average of the variation thereof were obtained for each of the test pieces. The results are shown in FIG. 1 and shown as a graph in FIG. 4. The respective numbers attached to the plots shown in FIG. 4 correspond to the numbers of the test pieces. From FIGS. 1 and 4, it can be understood that the No. 7, the No. 8, the No. 10, the No. 11, the No. 12, arid the No. 14 test pieces exhibit a comparatively large tensile strength, substantially the same level of stress, and a small variation in the tensile strength.

In contrast thereto, as shown in FIG. 4, in the comparative examples, different levels of stress were exhibited for each of the test pieces, and therefore, the variation in the tensile strength was large. More specifically, by making use of the compositions based on the first to third embodiments, a solder material in which the tensile strength (a mechanical characteristic) is stable at an extremely low temperature of −40° C. can be obtained.

A crystal orientation analysis was performed on the No. 2 test piece (comparative example) in which the tensile strength at −40° C. was less than 38 MPa, and on the No. 7 test piece (second embodiment), and the Schmidt factor was calculated. As a result, the No. 2 test piece in which the variation in the tensile strength was large exhibited a smaller Schmidt factor than that of the No. 7 test piece in which the variation was small. From such a fact, it can be inferred that the main cause of such a variation is anisotropy in the crystal orientation.

In addition, in the No. 7, the No. 8, the No. 10, the No. 11, the No. 12, and the No. 14 test pieces, the melting points thereof are all less than 210° C. Such a fact implies that the solder materials of the exemplary embodiments melt easily at a relatively low temperature.

Furthermore, upon carrying out microscopic observation of the structures of each of the test pieces of the comparative examples, it was confirmed that twinning deformation had occurred. From such a fact, it can be inferred that the reason why the variation in the tensile strength is large in the comparative examples is due to the fact that twinning deformation has occurred.

In contrast thereto, in the exemplary embodiments, as has been stated above, a stable tensile strength was exhibited even under an environment of −40° C., and twinning deformation was not recognized even when microscopic observation was carried out. From such a fact, it is clear that a solder material having a small variation in tensile strength can be obtained by having the compositions lie within the above-described ranges, and by setting the amount of Bi to substantially zero.

1. A solder material containing 0.5 to less than 2.5% by weight of Ag, 0.3 to 0.5% by weight of Cu, 5.5 to 6.4% by weight of In, and 0.5 to 1.4% by weight of Sb, with a remainder being unavoidable impurities and Sn, and containing substantially no Bi.

2. A solder material containing 2.5 to 3.3% by weight of Ag, 0.3 to 0.5% by weight of Cu, 2.5 to less than 5.5% by weight of In, and 0.5 to 1.4% by weight of Sb, with a remainder being unavoidable impurities and Sn, and containing substantially no Bi.

3. A solder material containing 2.5 to 3.3% by weight of Ag, 0.3 to 0.5% by weight of Cu, 5.5 to 6.4% by weight of In, and more than 1.4 to 3.4% by weight of Sb, with a remainder being unavoidable impurities and Sn, and containing substantially no Bi.
